(19) United States
(12) Patent Application Publication
(10) Pub. No.: US 2022/0164631 A1
(43) Pub. Date: May 26, 2022

(54) COMPUTER SYSTEM FOR PROFILING NEURAL FIRING DATA AND EXTRACTING CONTENT, AND METHOD THEREOF

(71) Applicant: Korea Advanced Institute of Science and Technology, Daejeon (KR)

(72) Inventors: Sang Wan Lee, Daejeon (KR); Minryung Song, Daejeon (KR)

(73) Assignee: Korea Advanced Institute of Science and Technology, Daejeon (KR)

(21) Appl. No.: 17/530,626

(22) Filed: Nov. 19, 2021

(30) Foreign Application Priority Data
Nov. 20, 2020 (KR) 10-2020-0156897

(51) Int. Cl. G06N 3/04; G06N 3/063

(52) U.S. Cl. CPC G06N 3/049; G06N 3/063

(57) ABSTRACT

Various example embodiments relate to a computer system for profiling neural firing data and extracting content and a method thereof, and it may be configured to profile the neural firing data based on time series data representing firing timepoint for at least one neural firing within a window defined by a predetermined time length, and extract the content for the neural firing from the neural firing data.

### CROSS REFERENCE TO RELATED APPLICATIONS

This application claims the priority benefit of Korean Patent Application No. 10-2020-0156897, filed on Nov. 20, 2020, in the Korean Intellectual Property Office, the disclosure of which is incorporated herein by reference.

### BACKGROUND

### 1. Field of the Invention

The following description relates to technology for machine learning method for profiling neural firing data and extracting content in neural network of living things or in hardware and software designed similar to the neural network, and it may be used for activity analysis and development of biological or artificial neural network.

### 2. Description of Related Art

How nervous system processes and transmits information is one of key questions of neuroscience. Therefore, a calculation method for extracting content that is estimated to be transmitted by neurons from firing time series data of neurons has been studied for a long time. However, this method had disadvantages that it does not match with characteristics of actual data, it requires too much data to be difficult to obtain through behavioral experiments, or it is inappropriate for behavioral experimenters to use because it is mathematically complex. As a result, although analyzing neural content during an animal (human) behaves is very important to understand brain, these means were not widely used in behavioral experiments. In behavioral experiments, only firing frequency was used, and abundant information contained in firing timepoint was not studied in depth. It was also difficult to study a section where firing timepoint of neurons changes but firing frequency little changes.

### SUMMARY

Various example embodiments provide a computer system which may profile neural firing data and extract content from the neural firing data through a machine learning decoder and a method thereof.

A method by a computer system according to various example embodiments may include profiling neural firing data based on time series data representing firing timepoint for at least one neural firing within a window defined by a predetermined time length, and extracting content for the neural firing from the neural firing data.

A computer system according to various example embodiments may include a memory, and a processor connected with the memory and configured to execute at least one instruction stored in the memory, and the processor may be configured to profile neural firing data based on time series data representing firing timepoint for at least one neural firing within a window defined by a predetermined time length; and extract content for the neural firing from the neural firing data.

A non-transitory computer-readable medium according to various example embodiments may include profiling neural firing data based on time series data representing firing timepoint for at least one neural firing data within a window defined by a predetermined time length, and extracting content for the neural firing from the neural firing data.

Various example embodiments may extract content contained in time series data for neural firing with a little data and quantify amount of information by using information for firing timepoint and firing frequency of neurons without loss and classifying them by machine learning.

### BRIEF DESCRIPTION OF THE DRAWINGS

These and/or other aspects, features, and advantages of the disclosure will become apparent and more readily appreciated from the following description of embodiments, taken in conjunction with the accompanying drawings of which:

FIG. 1 is a drawing illustrating a computer system according to various example embodiments;

FIG. 2 is a drawing for describing operating features of the computer system of FIG. 1;

FIGS. 3A, 3B, 3C, and 3D are drawings for describing operating examples of the computer system of FIG. 1;

FIG. 4 is a drawing illustrating a method by a computer system according to various example embodiments;

FIG. 5 is a drawing illustrating neural firing data profiling steps of FIG. 4;

FIG. 6 is a drawing illustrating content extracting steps of FIG. 4; and

FIGS. 7A, 7B, 7C, 8A, 8B, 8C, 8D, 8E, 8F, 8G, 9A, 9B, and 9C are drawings for describing experimental results using various example embodiments.

### DETAILED DESCRIPTION

Hereinafter, embodiments of the disclosure are described in detail with reference to the accompanying drawings.

To study brain or connect the brain to external devices to provide various services (brain-computer interaction), furthermore, to analyze and improve hardware and software made by imitation of neural network, it is essential to find out what information neurons transmit. Neurons transmit information by controlling how often and when they fire. Therefore, it should be possible to infer amount and content of information transmitted by neurons by considering both firing frequency and firing timepoint.

Various example embodiments propose a novel and simple analysis means based on activity of visual brain neurons responding to the degree of inclination of the line. Each of the neurons has an angle to which it responds most sensitively (e.g., 30 degrees), and it responds weakly to angles away from this angle. Functions of the angle and response strength of each neuron is called tuning curves. Although the number of neurons is limited, visual brain may recognize an infinite number of angles because the neurons partially overlap each other and have slightly different tuning curves. In various example embodiments, neural firing data is profiled from time series data so that each section has a tuning curve (time difference from the center of the section to the firing timepoint) similar to visual brain neurons, and content extraction and quantification are possible from neural firing data with a simple method of classification by machine learning.

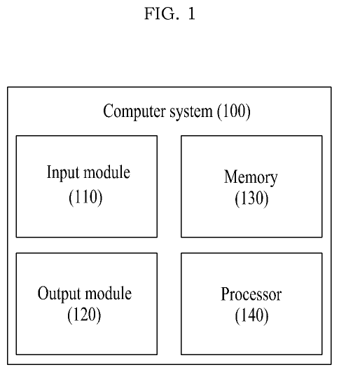

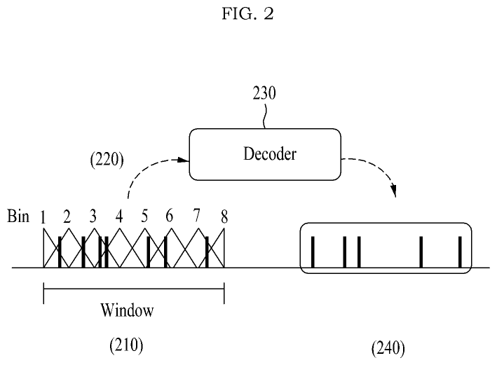

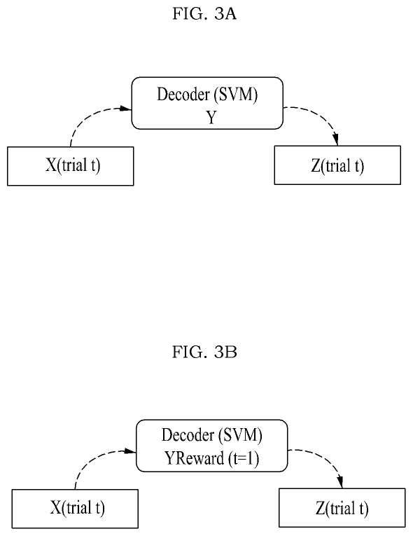

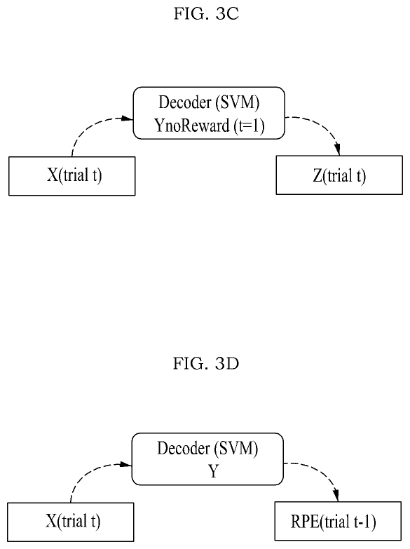

FIG. 1 is a drawing illustrating a computer system 100 according to various example embodiments. FIG. 2 is a drawing for describing operating features of the computer system 100 of FIG. 1. FIGS. 3A, 3B, 3C, and 3D are drawings for describing operating examples of the computer system 100 of FIG. 1.

Referring to FIG. 1, the computer system 100 according to various example embodiments may include at least one of an input module 110, an output module 120, a memory 130, or a processor 140. In some example embodiments, at least one of the elements of the computer system 100 may be omitted or at least another element may be added. In some example embodiments, at least two of the elements of the computer system 100 may be implemented as one integrated circuit. At this time, the computer system 100 may be configured with at least one device, for example, at least one of at least one server or at least one electronic device. In some example embodiments, when the computer system 100 includes a plurality of devices, the elements of the computer system 100 may be configured in one of the devices or distributed and configured in at least two of the devices.

The input module 110 may input signals to be used to at least one element of the computer system 100. The input module 110 may include at least one of an input device configured to directly input signals to the computer system 100, a sensor device configured to generate signals by sensing changes in the surroundings, or a receiving device configured to receive signals from external devices. For example, the input device may include at least one of a microphone, a mouse, or a keyboard. In some example embodiments, the input device may include at least one of a touch circuitry set to sense touch or a sensor circuitry set to measure force generated by touch.

The output module 120 may output information to the outside of the computer system 100. The output module 120 may include at least one of a display device configured to output information visually, an audio output device which may output information into audio signals, or a transmitting device which may transmit information wirelessly. For example, the display device may include at least one of a display, a hologram device, or a projector. As one example, the display device may be assembled with at least one of the touch circuitry or the sensor circuitry of the input module 110, and implemented in a touch screen. For example, the audio output device may include at least one of a speaker or a receiver.

According to one example embodiment, the receiving device and the transmitting device may be implemented as a communication module. The communication module may perform communication with external devices in the computer system 100. The communication module may set a communication channel between the external devices, and perform communication with the external devices through the communication channel. Here, the external devices may include at least one of a satellite, a base station, or another computer system. The communication module may include at least one of a wired communication module and a wireless communication module. The wireless communication module may be connected via wires to an external device and communicate with it via wires. The wireless communication module may include at least one of a short-range communication module or a long-range communication module. The short-range communication module may communicate with an external device by a short-range communication method. The short-range communication method may include, for example, at least one of Bluetooth, WiFi direct, and Infrared data association (IrDA). The long-range communication module may communicate with an external device by a long-range communication method. Here, the long-range communication module may communicate with an external device through a network. The network may include, for example, at least one of a cellular network, the Internet, and a computer network such as LAN (local area network) or WAN (wide area network).

The memory 130 may store various data used by at least one element of the computer system 100. The memory 130 may include, for example, at least one of volatile memory and nonvolatile memory. The data may include at least one program and input data or output data associated therewith. The program may be stored as software in the memory 130, and may include, for example, at least one of an operating system, middleware, or an application.

The processor 140 may execute the program of the memory 130 and control at least one element of the computer system 100. Through this, the processor 140 may perform data processing or calculation. At this time, the processor 140 may execute the instructions stored in the memory 130.

According to various example embodiments, the processor 140 may profile neural firing data 220 based on time series data 210 representing firing timepoint for at least one neural firing within a window defined by a predetermined time length. At this time, the computer system 100 may profile the neural firing data 220 based on all of the firing timepoint and firing frequency of the neural firing within the window. In other words, when the neural firing data 220 is profiled, both of the firing timepoint and the firing frequency are not lost from the time series data 210.

As shown in FIG. 2, the processor 140 may divide the window into a plurality of sections. Here, each of the sections may be overlapped with at least one adjacent section through at least one of both ends. Also, for the timepoints within each of the sections, neural firing values within a predetermined range may be assigned. Here, the upper value of the range may be assigned to the center in each of the sections, and the lower value of the range may be assigned to both endpoints of the sections, respectively. In addition, a smaller value may be assigned from the center of each of the sections to both endpoints, i.e., further away from the center, or closer to both endpoints.

The processor 140 may detect a neural firing value for each of the sections based on the firing timepoint in each of the sections. According to one example embodiment, when there is one firing timepoint in one of the sections, the processor 140 may detect a neural firing value for the firing timepoint based on a location of the firing timepoint within the section. According to another example embodiment, when there are a plurality of firing timepoints in one of the sections, the processor 140 may detect individual neural firing values for the firing timepoints, respectively, based on locations of the firing timepoints within the section, and may add up the individual neural firing values. Through this, the processor 140 may detect the neural firing value for the section.

The processor 140 may acquire the neural firing data 220 by combining the neural firing values of the sections. Through this, in the neural firing data 220, all of firing timepoint and firing frequency of neural firing within the window may be provided.

According to various example embodiments, the processor 140 may extract content 240 from the neural firing data 220. The processor 140 may extract the content 240 from the neural firing data 220 by using at least one machine learning decoder 230 as shown in FIG. 2. For example, the decoder 230 may be a SVM (support vector machine), but it is not limited thereto. At this time, since the neural firing data 220 is profiled without loss of both firing timepoint and firing frequency of neural firing, the processor 140 may efficiently extract the content 240 with higher accuracy.

The processor 140 may extract content estimation information from the neural firing data 220. For this, the processor 140 may learn the neural firing data 220 by using the machine learning decoder 230. At this time, the processor 140 includes a plurality of decoders 230, and the different content types may be assigned to the decoders, respectively. Also, the processor 140 inputs neural firing data 220 to the decoders 230, respectively, and accordingly, the decoders 230 learn the neural firing data 220, respectively, and as a result, at least one of the decoders 230 may output content estimation information extracted from the neural firing data 220. Through this, the processor 140 may identify the content type assigned to at least one decoder 230 outputting the content estimation information as the content type of the neural firing data 220 and the content estimation information, and may extract the content estimation information. According to one example embodiment, the content estimation information may be amount of information sharing with the neural firing data 220 of another window for the neural firing data 220 of the current window, other neurons of other parts, or activities of other neurons of other animals (including devices or people).

The processor 140 may extract the quantified content 240 from the content estimation information based on the content type. According to one example embodiment, the processor 140 may detect effects of the content type for the content estimation information. Through this, the processor 140 may extract the quantified content 240 from the content estimation information based on the effects of the content type. For example, when the content type is an external stimulus or animals (or people)'s behavior, the processor 140 may extract the quantified content 240 based on the effects of the external stimulus or the animals' behavior for the content estimation information.

For example, as shown in FIGS. 3A, 3B, 3C, or 3D, for the neural firing data 220 (X), the decoder 230 may extract the content 240 by quantifying the amount (Y) of the content estimation information (Z). As shown in FIG. 3A, the decoder 230 may extract amount of information sharing for the neural firing data 220 of the current window. For example, the amount of information sharing may be extracted as the content estimation information (Z). As one example, as shown in FIG. 3B or 3C, when the content type is the external stimulus, the decoder 230 may extract the amount (Y) of the content estimation information (Z) depending on the presence or absent of reward which is the external stimulus. Meanwhile, as shown in FIG. 3D, when the content type is an estimation error for the previous window, the decoder 230 may extract the amount (Y) of estimation error information included in the neural firing data 220.

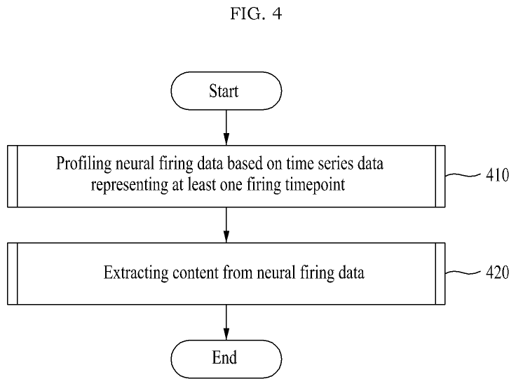

FIG. 4 is a drawing illustrating a method by a computer system according to various example embodiments. At this time, FIG. 4 represents a method for profiling the neural firing data 220 and extracting the content 240 by the computer system 100.

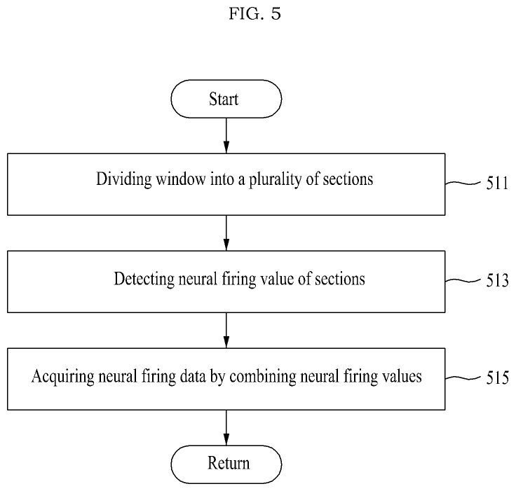

Referring to FIG. 4, the computer system 100 may profile the neural firing data 220 based on the time series data 210 representing firing timepoint for at least one neural firing within a window defined by a predetermined time length in Step 410. At this time, the computer system 100 may profile the neural firing data 220 based on all of firing timepoint and firing frequency of neural firing within the window. In other words, when the neural firing data 220 is profiled, the firing timepoint or the firing frequency of the neural firing may be not lost from the time series data 210. For this, it will be described in more detail below with reference to FIG. 5.

FIG. 5 is a drawing illustrating the neural firing data 220 profiling steps (Step 410) of FIG. 4.

Referring to FIG. 5, the computer system 100 may divide a window into a plurality of sections (or bins) in Step 511. At this time, the processor 140 may divide the window into a plurality of sections as shown in FIG. 2. Here, each of sections may be overlapped with at least one adjacent section through at least one of both ends. For example, the first section and the last section of the sections may be overlapped with an adjacent section through one end, and the rest of the sections may be overlapped with each of adjacent sections through both ends, respectively. Also, for timepoints within each of the sections, neural firing values within a predetermined range may be assigned. Here, the upper value of the range is assigned to the center in each of the sections, and the lower value of the range is assigned to both endpoints in each of the sections, respectively. In addition, a smaller value may be assigned from the center of each of the sections to both endpoints, i.e., further away from the center, or closer to both endpoints.

The computer system 100 may detect neural firing values of the sections, respectively, in Step 513. At this time, the processor 140 may detect a neural firing value for each of the sections, based on the firing timepoint in each of the sections. According to one example embodiment, when there is one firing timepoint in one of the sections, the processor 140 may detect a neural firing value for the firing timepoint based on a location of the firing timepoint within the section. Through this, the processor 140 may detect the neural firing value for the section. For example, when one firing timepoint is located in the center of the section, the processor 140 may detect the upper value within the predetermined range as the neural firing value of the firing timepoint, and then, detect the firing value of the section. According to another example embodiment, when there are a plurality of firing timepoints in one of the sections, the processor 140 may detect individual firing values for the firing timepoints respectively based on locations of the firing timepoints within the section. Also, the processor 140 may add up the individual neural firing values and detect it as the neural firing value for the section. For example, when the firing timepoints are located in the center of the section and in the middle between the center and one end, the processor 140 may detect the upper value and the median value within the predetermined range as the individual neural firing values of the firing timepoints, respectively, and then, may add up the upper value and the median value and detect it as the neural firing value of the section.

The computer system 100 may acquire the neural firing data 220 by combining the neural firing values of the sections in Step 515. Through this, in the neural firing data 220, all of the firing timepoint and the firing frequency of the neural firing within the window may be provided. After this, the computer system may return to FIG. 4 and proceed with Step 430.

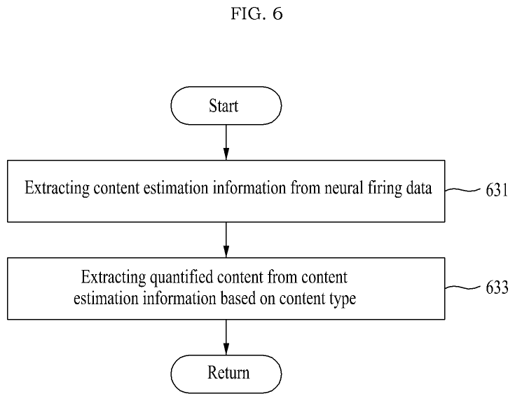

Referring to FIG. 4 again, the computer system 100 may extract the content 240 from the neural firing data 220 in Step 430. The processor 140 may extract the content 240 from the neural firing data 220 by using at least one machine learning decoder 230 as shown in FIG. 2. For example, the decoder 230 may be a SVM (support vector machine), but it is not limited thereto. At this time, since the neural firing data 220 is profiled without loss of at least one of the firing timepoint or the firing frequency of the neural firing, the processor 140 may efficiently extract the content 240 with higher accuracy. Regarding this, it will be described in more detail below with reference to FIG. 6.

FIG. 6 is a drawing illustrating the content 240 extracting steps (Step 430) of FIG. 4.

Referring to FIG. 6, the computer system 100 may extract content estimation information from the neural firing data 220 in Step 631. For this, the processor 140 may learn the neural firing data 220 by using the machine learning decoder 230. At this time, the processor 140 may include a plurality of decoders 230, and different content types may be assigned to the decoders 230. Also, the processor 140 may input the neural firing data 220 to the decoders 230, respectively, and accordingly, the decoders 230 may learn the neural firing data 220, respectively, and as a result, at least one of the decoders 230 may output content estimation information extracted from the neural firing data 220. Through this, the processor 140 may identify the content type assigned to at least one decoder 230 outputting the content estimation information as the content type of the neural firing data 220 and the content estimation information, and may extract the content estimation information. According to one example embodiment, the content estimation information may be information sharing with the neural firing data 220 of a subsequent window of the neural firing data 220 of the current window.

The computer system 100 may extract the quantified content 240 from the content estimation information based on the content type in Step 633. According to one example embodiment, the processor 140 may detect effects of the content type for the content estimation information. Through this, the processor 140 may extract the quantified content 240 from the content estimation information based on the effects of the content type. For example, when the content type is an external stimulus or an estimation error for the previous window, the processor 140 may extract the quantified content 240 based on the effects of the external stimulus or the animals' behavior for the content estimation information.

For example, as shown in FIGS. 3A, 3B, 3C, or 3D, for the neural firing data 220 (X), the decoder 230 may extract the content 240 by quantifying the amount (Y) of the content estimation information (Z). As shown in FIG. 3A, the decoder 230 may extract amount of information sharing for the neural firing data 220 of the current window. For example, the amount of information sharing may be extracted as the content estimation information (Z). As one example, as shown in FIG. 3B or 3C, when the content type is the external stimulus, the decoder 230 may extract the amount (Y) of the content estimation information (Z) depending on the presence or absent of reward which is the external stimulus. Meanwhile, as shown in FIG. 3D, when the content type is an estimation error for the previous window, the decoder 230 may extract the amount (Y) of estimation error information included in the neural firing data 220.

According to the various example embodiments, the computer system 100 may extract content included in the time series data for the neural firing with a little data and quantify information amount by using information for the firing timepoint and the firing frequency of neurons without loss and classifying it with machine learning.

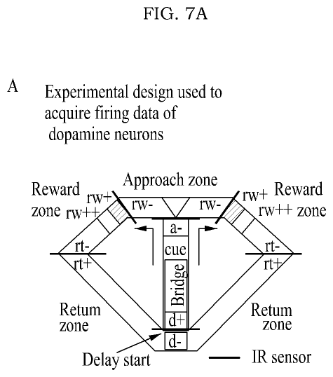

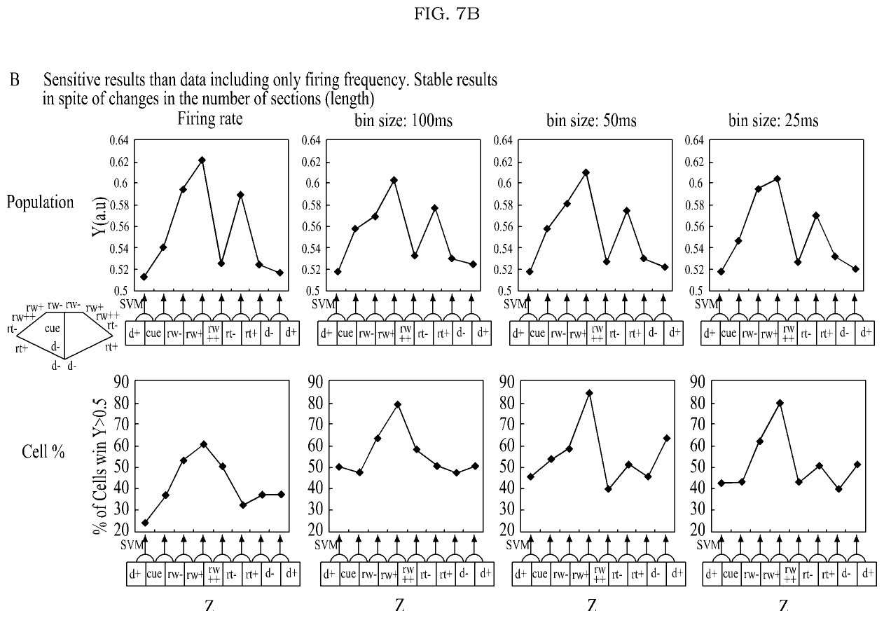

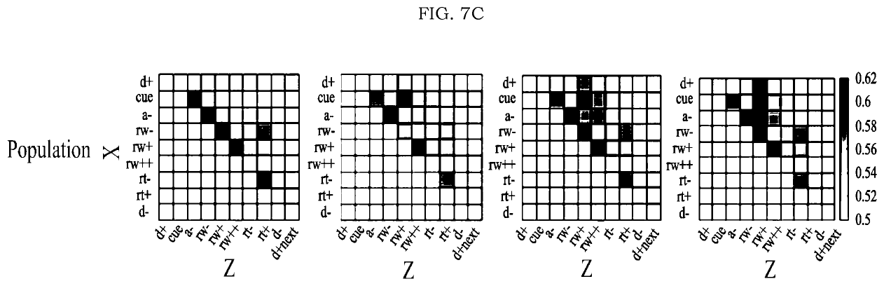

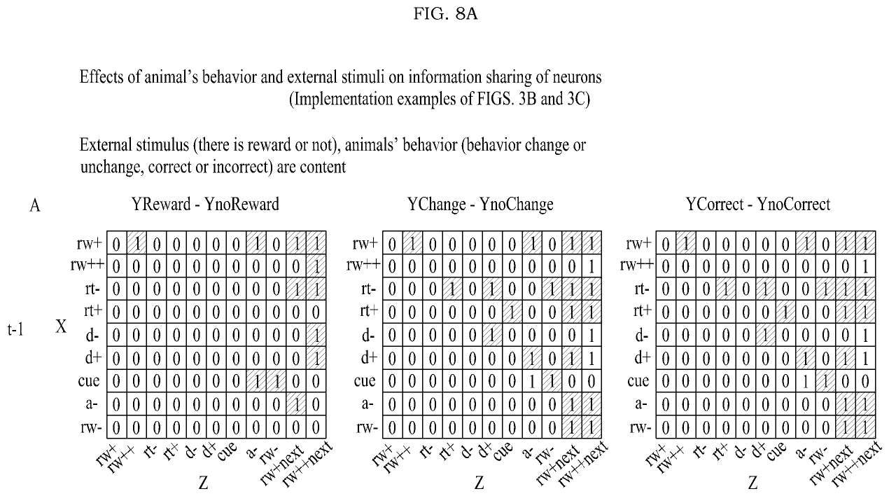

FIGS. 7A, 7B, 8A, 8B, 8C, 8D, 8E, 8F, 8G, 9A, 9B, and 9C are drawings for describing experimental results using various example embodiments.

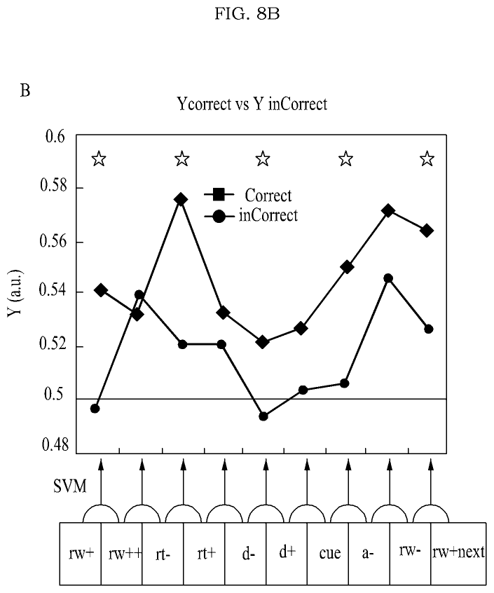

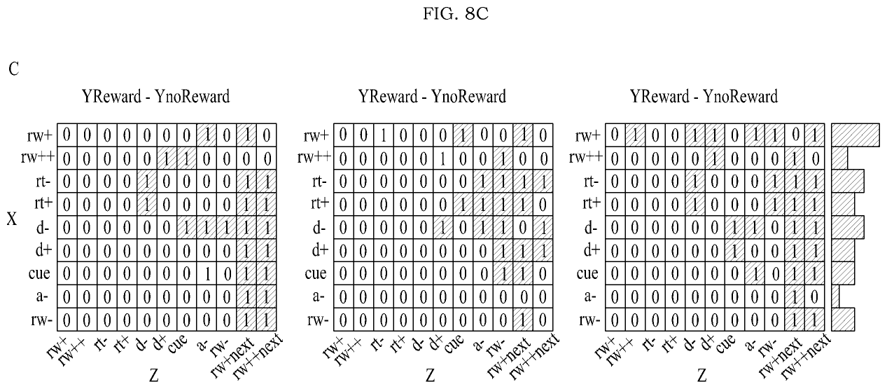

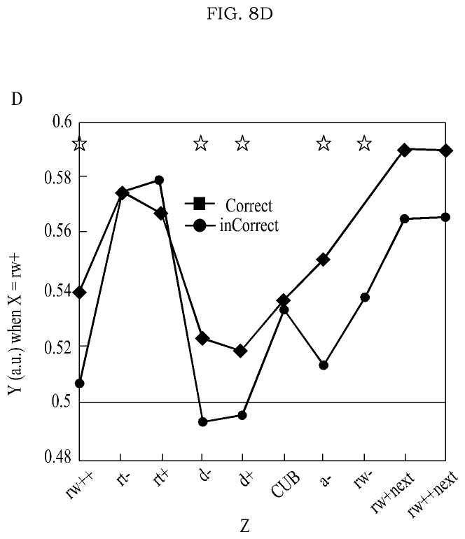

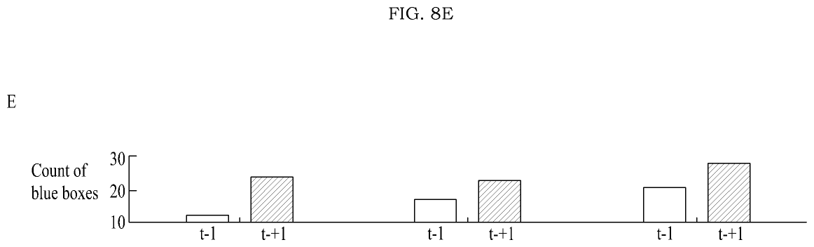

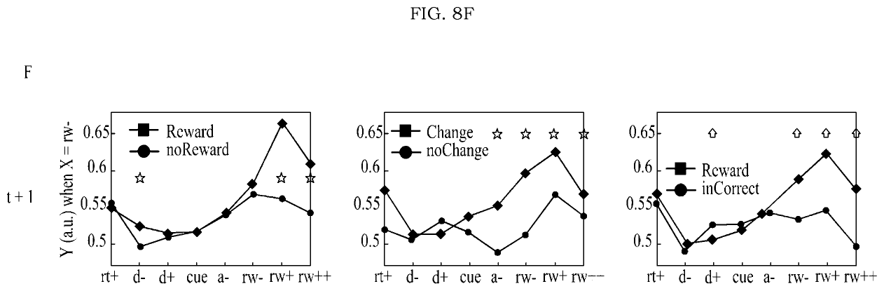

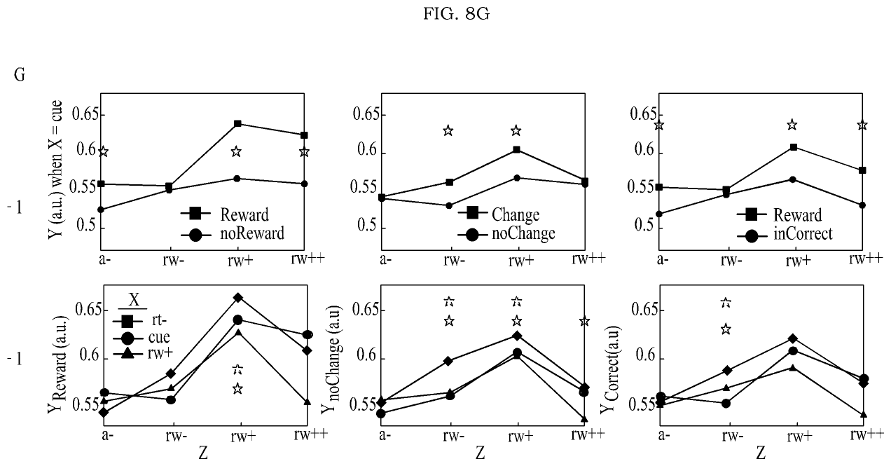

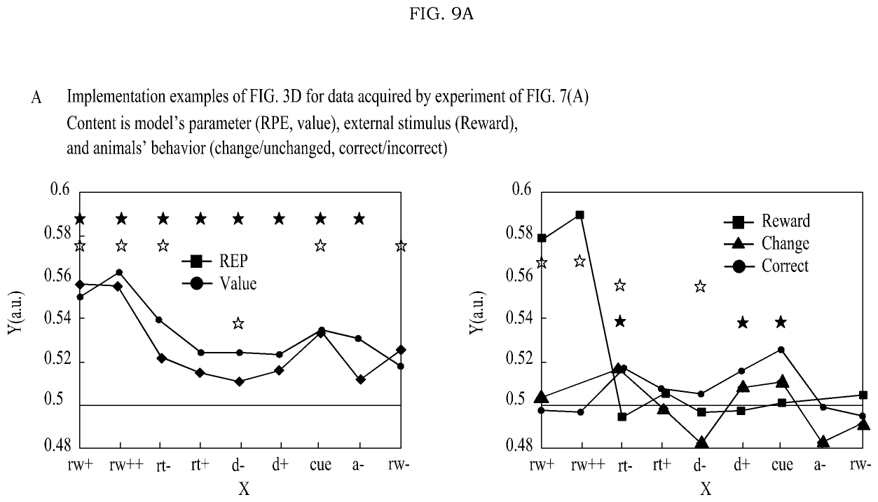

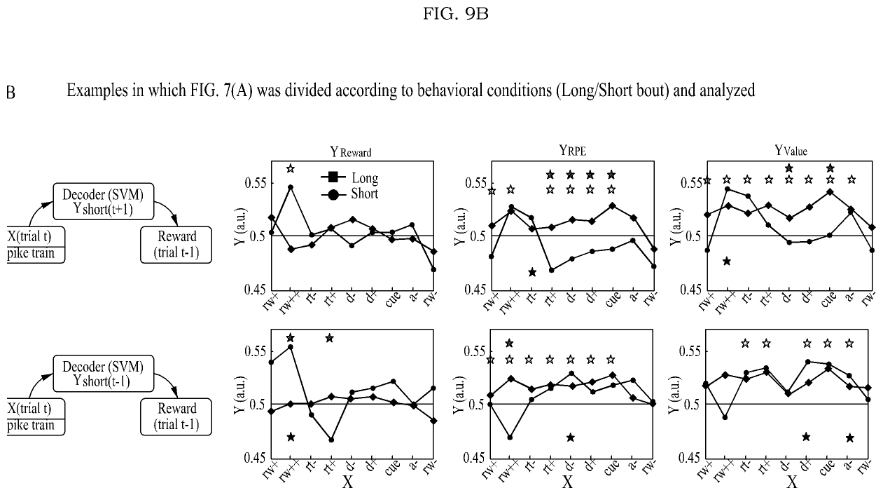

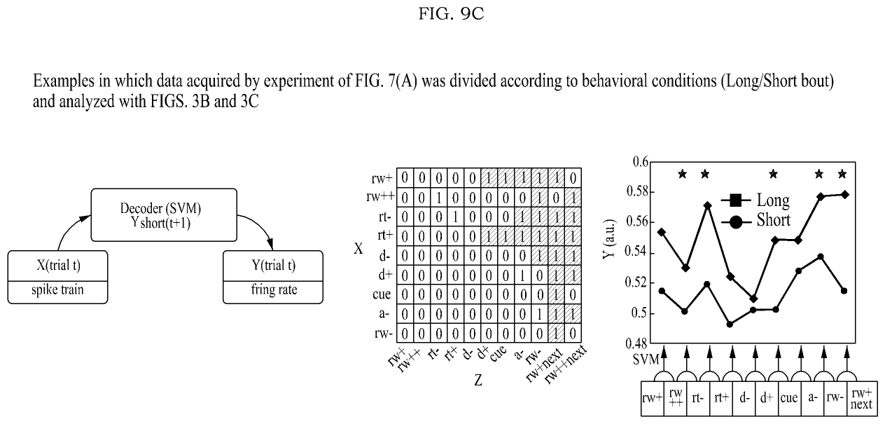

Referring to FIGS. 7A, 7B, 8A, 8B, 8C, 8D, 8E, 8F, 8G, 9A, 9B, and 9C, a method according to various example embodiments is actually used to examine that dopamine neurons in brain indicates which information in reinforcement learning, and how the information that dopamine neurons indicates changes depending on task performance. As shown in FIGS. 7A and 7B, the method according to various example embodiments is much more sensitive than the existing method analyzing only firing frequency, and less affected to the number of sections. Also, inter-trial interval has been rarely studies because there is little change in the firing frequency of dopamine neurons. However, it was found that dopamine neurons process various information during the section by using the method according to various example embodiments. As shown in FIGS. 8A, 8B, 8C, 8D, 8E, 8F, 8G, 9A, 9B, and 9C, it was newly derived that the kinds and amount of information content transmitted by dopamine neurons are changed depending on learning progress.

According to various example embodiments, while the computer system 100 profiles the neural firing data 220 from the time series data 210, both of the firing timepoint and the firing frequency of the neural firing are not lost from the time series data 210. Particularly, in each of the sections, as neural firing values are assigned smaller from the center to both endpoints, the firing timepoint has a continuous value, so the firing timepoint may not be lost. Also, in each of the sections, as individual neural firing values for firing timepoint are added up, the firing frequency of the neural firing may not be lost, and even if the number of sections within the window is changed, the analysis result may be not significantly changed. According to various example embodiments, the computer system 100 may extract content from the neural firing data profiled from the time series data. In other words, the computer system 100 may easily extract content by using a little data in machine learning analysis. This may enable analysis of sections that could not be analyzed because there is only a change in the firing timepoint of neurons and a small change in firing frequency in behavioral experiment.

In various example embodiments, the content type which is estimated that neural activity will transmit it is not limited to a particular type. For example, the content type may represent all information which may be output of machine learning such as presence or absent of an external stimulus, task performance of animals (or people), parameter of theory model for learning, and the like. Activities of one neuron and another neuron, and one phase and another phase of a neuron may be compared with the same method. Therefore, the various example embodiments may be used in all fields which need time series data analysis for neural firing of neurons.

The various example embodiments may be widely used to extract content included in activities of neurons. Also, it may be used in various fields which needs operation analysis and development of hardware and software similarly designed with neural network. Some examples thereof are as follows. First, as human-robot/computer interaction field, it needs to analyze information included in neural activities with a relatively small amount of personal data for brain-robot computer interaction. Since the various example embodiments allow analysis of information included in neural firing with a little data, it is expected to greatly contribute to development of brain-robot/computer interaction products. Secondly, as neuroscience field, it is essential to analyze which information activities of neurons occurring during an animal performs a particular task include in neuroscience research. The various example embodiments facilitate analyzing information included in a relatively small amount of neural firing data acquired during such behavioral experiment. In addition, since the technology is simple and flexible, it may be actively used in various neuroscience researches. Thirdly, as research and development field of a service using deep learning, unlike existing programs performing logical operations in order, it is difficult for even developers to find out the basis for drawing conclusion of deep learning one by one. It is because information is distributed in nodes of artificial neural network and processed. To check and improve performance of the deep learning, it is useful to profile how and which information the nodes of the artificial neural network process. The various example embodiments may be used in such profiling. Also, since the various example embodiments provide means required to understand the process for drawing conclusion of deep learning, utilization of the deep learning may be increased in various fields where user understanding is important (e.g., medical diagnosis, vocational training, and the like). Fourthly, as neuromorphic chip field, interest in neuromorphic chip made by imitating activities of neural network is rapidly increasing in semiconductor field. The neuromorphic chip may perform complex operations such as deep learning and the like with only small power that is only 1/1000 of a traditional CPU. Since the neuromorphic chip also distributes and processes information such as animal's brain and deep learning, it is difficult to analyze operation of the neuromorphic chip with a traditional method. The various example embodiments may be usefully used in development of the neuromorphic chip.

Expectations for brain-robot/computer interaction have been high for a long time, but commercialization has not been easy. One of the reasons for this is that it is difficult to analyze content included in neural activities with a small amount of personal data. The various example embodiments may be widely used in the brain-robot/computer interaction field by solving the difficulty. Also, the various example embodiments may increase utilization of the deep learning in various fields where it is important to convince users of the process of drawing conclusions.

It is expected that the various examples will be usefully used for studying neural activities in behavioral neuroscience. In addition, it is expected that it will be widely used in brain-robot/computer interaction products that need analysis of firing pattern of neurons. It will be helpful for development of artificial intelligence service and artificial intelligence research and development that require users to understand the process of drawing conclusion of deep learning.

The various example embodiments are applicable to all brain-robot/computer interaction products that need analysis of firing pattern of neurons. It may be used for various services that help people learn and make decisions by showing the process for drawing conclusion of deep learning.

The method by the computer system 100 according to various example embodiments may include profiling the neural firing data 220 based on the time series data 210 representing the firing timepoint for at least one neural firing within the window defined by a predetermined time length and extracting the content 240 for the neural firing from the neural firing data 220.

According to the various example embodiments, the profiling the neural firing data 220 may include dividing the window into a plurality of sections—each of sections is overlapped with at least one adjacent sections through at least one of both ends—, detecting a neural firing value for each of the sections based on the firing timepoint in each of the sections, and acquiring the neural firing data 220 by combining the neural firing values for all of the sections.

According to various example embodiments, the neural firing value may be detected as one value within a predetermined range—the upper value of the range is assigned to the center in each of the sections, and the lower value of the range is assigned to both endpoints in each of the sections respectively—, and detected as a smaller value as the firing timepoint in each of the sections is further away from the center.

According to various example embodiments, the detecting the neural firing value for each of the sections may comprise detecting individual neural firing values for the firing timepoint if there are a plurality of firing timepoints in one of the sections, and detecting a neural firing value for one of the sections by adding up the individual firing values.

According to various example embodiments, the extracting the content 240 may include extracting content estimation information from the neural firing data 220 by learning the neural firing data 220, and extracting the quantified content 240 from the content estimation information.

According to various example embodiments, the extracting the content estimation information may include inputting the neural firing data 220 to a plurality of decoders 230 that each of different content types are assigned, and extracting the content estimation information while identifying the content type of the content estimation information as the content estimation information is output from at least one of the decoders 230.

According to various example embodiments, the extracting the quantified content 240 may include extracting the quantified content 240 from the content estimation information based on the content type.

According to various example embodiments, the extracting the quantified content 240 may include detecting effects of the content type for the content estimation information, and extracting the quantified content 240 from the content estimation information based on the effects of the content type.

The computer system 100 according to various example embodiments may include the memory 130, the processor 140 connected with the memory 130 and configured to execute at least one instruction stored in the memory 130.

According to various example embodiments, the processor 140 may be configured to profile the neural firing data 220 for the neural firing from the time series data 210 representing the firing timepoint for at least one neural firing within the window defined by a predefined time length, and extract the content 240 for the neural firing from the neural firing data 220.

According to various example embodiments, the processor 140 may be configured to divide the window into a plurality of sections—each of the sections is overlapped with at least one adjacent section through at least one of both ends—, detect a neural firing value for each of the sections based on the firing timepoint in each of the sections, and acquire the neural firing data 220 by combining neural firing values for all of the sections.

According to various example embodiments, the neural firing value may be configured to be detected as one value within a predetermined range—the upper value of the range is assigned to the center in each of the sections, and the lower value of the range is assigned to both endpoints in each of the sections, respectively—, and detected as a smaller value as the firing timepoint is further away from the center.

According to various example embodiments, the processor 140 may be configured to detect individual neural firing values for the firing timepoints, respectively, if there are a plurality of firing timepoints, and detect a neural firing value for one of the sections by adding up the individual neural firing values.

According to various example embodiments, the processor 140 may be configured to extract content estimation information from the neural firing data 220 by learning the neural firing data 220, and extract quantified content 240 from the content estimation information.

According to various example embodiments, the processor 140 may be configured to input the neural firing data 220 respectively to a plurality of decoders 230 that each of different content types is assigned, and extract the content estimation information while identifying the content type of the content estimation information as the content estimation information is output from at least one of the decoders 230.

According to various example embodiments, the processor 140 may be configured to extract the quantified content 240 from the content estimation information based on the content type.

According to the carious example embodiments, the processor 140 may be configured to detect effects of the content type for the content estimation information, and extract the quantified content 240 from the content estimation information based on the effects of the content type.

The system and device described herein may be implemented using hardware components, software components, and/or a combination thereof. For example, the device and components described in the example embodiments may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The method according to the various example embodiments may be implemented in the form of a program instruction executable by various computer means and stored in a computer-readable storage medium. The media may also include, alone or in combination with the program instructions, data files, data structures, and the like. The medium may continue to store a program executable by a computer or may temporarily store the program for execution or download. Furthermore, the medium may be various recording means or storage means of a form in which one or a plurality of pieces of hardware has been combined. The medium is not limited to a medium directly connected to a computer system, but may be one distributed over a network. Examples of the medium may be magnetic media such as a hard disk, a floppy disk and a magnetic tape, optical media such as a CD-ROM and a DVD, magneto-optical media such as a floptical disk, and media configured to store program instructions, including, a ROM, a RAM, and a flash memory. Furthermore, other examples of the medium may include an app store in which apps are distributed, a site in which various pieces of other software are supplied or distributed, and recording media and/or storage media managed in a server.

It should be understood that various embodiments of this document and terms used in the embodiments do not limit technology described in this document to a specific embodiment and include various changes, equivalents, and/or replacements of a corresponding embodiment. The same reference numbers are used throughout the drawings to refer to the same or like parts. Unless the context otherwise clearly indicates, words used in the singular include the plural, and the plural includes the singular. In this document, an expression such as “A or B” and “at least one of A or/and B”, “A, B or, C” or “at least one of A, B, or/and C” may include all possible combinations of together listed items. An expression such as “first” and “second” used in this document may indicate corresponding components regardless of order or importance, and such an expression is used for distinguishing a component from another component and does not limit corresponding components. When it is described that a component (e.g., a first component) is “(functionally or communicatively) coupled to” or is “connected to” another component (e.g., a second component), it should be understood that the component may be directly connected to the another component or may be connected to the another component through another component (e.g., a third component).

The term “module” used herein may include a unit including hardware, software, or firmware, and, for example, may be interchangeably used with the terms “logic,” “logical block,” “component” or “circuit”. The “module” may be an integrally configured component or a minimum unit for performing one or more functions or a part thereof. For example, the “module” be configured in the form of an Application-Specific Integrated Circuit (ASIC).

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. A method by a computer system, comprising:
profiling neural firing data based on time series data representing firing timepoint for at least one neural firing within a window defined by a predetermined time length; and
extracting content for the neural firing from the neural firing data.

2. The method of claims 1, wherein the profiling of the neural firing data comprises:
dividing the window into a plurality of sections—each of the sections is overlapped with at least one adjacent section through at least one of both ends—;
detecting a neural firing value for each of the sections based on the firing timepoint in each of the sections; and
acquiring the neural firing data by combining neural firing values for all of the sections.

3. The method of claim 2, wherein the neural firing value is configured to be detected as one value within a predetermined range—the upper value of the range is assigned to the center in each of the sections, and the lower value of the range is assigned to both endpoints in each of the sections, respectively—; and detected as a smaller value as the firing timepoint in each of the sections is further away from the center.

4. The method of claim 2, wherein the detecting of the neural firing value for each of the sections comprises:
detecting individual neural firing values for the firing timepoints, respectively, if there are a plurality of firing timepoints in one of the sections; and
detecting a neural firing value for one of the sections by adding up the individual neural firing values.

5. The method of claim 1, wherein the extracting of the content comprises:
extracting content estimation information from the neural firing data by learning the neural firing data; and
extracting quantified content from the content estimation information.

6. The method of claim 5, wherein the extracting of the content estimation information comprises:
inputting the neural firing data respectively to a plurality of decoders that each of different content types is assigned; and
extracting the content estimation information while identifying the content type of the content estimation information as the content estimation information is output from at least one of the decoders.

7. The method of claim 6, wherein the extracting of the quantified content comprises extracting the quantified content from the content estimation information based on the content type.

8. The method of claim 6, wherein the extracting of the quantified content comprises:
detecting effects of the content type for the content estimation information; and
extracting the quantified content from the content estimation information based on the effects of the content type.

9. A computer system, comprising:
a memory; and
a processor connected with the memory and configured to execute at least one instruction stored in the memory,
wherein the processor is configured to profile neural firing data based on time series data representing firing point for at least one neural firing within a window defined by a predetermined time length; and extract content for the neural firing from the neural firing data.

10. The computer system of claim 9, wherein the processor is configured to:
divide the window into a plurality of sections—each of the sections is overlapped with at least one adjacent section through at least one of both ends—;
detect a neural firing value for each of the sections based on the firing timepoints in each of the sections; and
acquire the neural firing data by combining neural firing values for all of the sections.

11. The computer system of claim 10, wherein the neural firing value is configured to be detected as one value within a predetermined range—the upper value of the range is assigned to the center in each of the sections, and the lower value of the range is assigned to both endpoints in each of the sections, respectively—; and detected as a smaller value as the firing timepoint in each of the sections is further away from the center.

12. The computer system of claim 10, wherein the processor is configured to:
detect individual neural firing values for firing timepoints, respectively, if there are a plurality of firing timepoints in one of the sections; and
detect a neural firing value for one of the sections by adding up the individual neural firing values.

13. The computer system of claim 9, wherein the processor is configured to:
extract content estimation information from the neural firing data by learning the neural firing data; and
extract quantified content from the content estimation information.

14. The computer system of claim 13, wherein the processor is configured to:
input the neural firing data respectively to a plurality of decoders that each of different content types is assigned; and
extract the content estimation information while identifying the content type of the content estimation information as the content estimation information is output from at least one of the decoders.

15. The computer system of claim 14, wherein the processor is configured to extract the quantified content from the content estimation information based on the content type.

16. The computer system of claim 14, wherein the processor is configured to:
detect effects of the content type for the content estimation information; and
extract the quantified content from the content estimation information based on the effects of the content type.

17. A non-transitory computer-readable medium for storing at least one program, wherein the computer-readable medium is configured to execute:
profiling neural firing data based on time series data representing firing timepoint for at least one neural firing data within a window defined by a predetermined time length; and
extracting content for the neural firing from the neural firing data.

18. The computer-readable medium of claim 17, wherein the profiling the neural firing data comprises:
dividing the window into a plurality of sections—each of the sections is overlapped with at least one adjacent section through at least one of both ends—;
detecting a neural firing value for each of the sections based on the firing timepoint in each of the sections; and
acquiring the neural firing data by combining neural firing values for all of the sections.

19. The computer-readable medium of claim 18, wherein the neural firing value is configured to be detected as one value within a predetermined range—the upper value of the range is assigned to the center in each of the sections, and the lower value of the range is assigned to both endpoints in each of the sections, respectively—; and detected as a smaller value as the firing timepoint in each of the sections is further away from the center.

20. The computer-readable medium of claim 18, wherein the detecting the neural firing value for each of the sections comprises:
detecting individual neural firing values for firing timepoints, respectively, if there are a plurality of firing timepoints in one of the sections; and
detecting a neural firing value for one of the sections by adding up the individual neural firing values.
